(19) United States
(12) Patent Application Publication
(10) Pub. No.: US 2015/0350785 A1
(43) Pub. Date: Dec. 3, 2015

(54) Improved Wireless Audio System

(71) Applicant: Peerless Industries, Inc., Aurora, IL (US)

(72) Inventors: Derrik Quang Lam, Chicago, IL (US); Paul Berkley, Shorewood, IL (US); Frank Laurendi, Plainfield, IL (US); Todd Mares, Batavia, IL (US); Don Schmidt, Romeoville, IL (US); Patrick Flanagan, Carlsbad, CA (US)

(73) Assignee: Peerless Industries, Inc., Aurora, IL (US)

(21) Appl. No.: 14/648,844

(22) PCT Filed: Dec. 2, 2013
(86) PCT No.: PCT/US13/72646

§ 371 Date: Jun. 1, 2015

Related U.S. Application Data
(60) Provisional application No. 61/734,008, filed on Dec. 6, 2012.

(51) Int. Cl. H04R 3/12

(52) U.S. Cl. CPC H04R 3/12; H04R 2420/07

(57) ABSTRACT

A wireless audio distribution system for wirelessly transmitting audio from a wireless transmitter to one or more speakers located remotely from the transmitter. A number of channels of audio are acoustically connected to a wireless transmitter unit. The wireless transmitter unit is configured for potential placement within a standard audio/video equipment rack, without the wireless audio signals suffering from substantial degradation resulting from such placement. The channels of audio are at least selectively transmitted wirelessly to an amplifier/receiver module located on a wall, contained within a wall or positioned within a ceiling. In the situation where the amplifier/receiver module is recessed within the wall, a low profile cover is attached to the wall, concealing the amplifier/receiver unit from view. A modular design method is utilized, allowing for the altering of pre-installed products at a later date. Components may be selected from across multiple product lines.

### CROSS-REFERENCE TO RELATED APPLICATIONS

The present application claims priority to U.S. Provisional Patent Application No. 61/734,008, filed Dec. 6, 2012. The contents of this application are incorporated herein by reference.

### BACKGROUND

The present invention relates generally to audio systems for distributing audio signals to one or more locations. More particularly, the present invention relates to wireless audio distribution systems that at least selectively distribute audio signals to multiple rooms or locations within a home or other building.

### SUMMARY

Various embodiments provide for a wireless audio distribution system that is used to wirelessly transmit audio from a wireless transmitter to one or more receivers with amplifiers located remotely from the transmitter. A plurality of channels of audio (up to eight channels in one implementation) are acoustically connected to a wireless transmitter unit. The wireless transmitter unit is configured for placement within a standard audio/video equipment rack, without the wireless audio signals suffering from substantial degradation resulting from such placement. The channels of audio are at least selectively transmitted wirelessly to an amplifier/receiver module located on a wall, contained within a wall or contained within a ceiling. In the situation where the amplifier/receiver module is recessed within the wall, a low profile cover is attached to the wall, concealing the amplifier/receiver unit from view. The wireless audio distribution system, according to various embodiments, utilizes a modular design method, allowing for the altering of pre-installed products at a later date, and components may be selected across multiple product lines.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a schematic representation of a wireless audio distribution system constructed in accordance with various embodiments.

FIG. 2(a) is a front perspective view of a wireless transmitter unit constructed in accordance with one embodiment; FIG. 2(b) is a top plan view of the wireless transmitter unit of FIG. 2(a); FIG. 2(c) is a bottom plan view of the wireless transmitter unit of FIG. 2(a); FIG. 2(d) is a left side elevational view of the wireless transmitter unit of FIG. 2(a); FIG. 2(e) is a right side elevational view of the wireless transmitter unit of FIG. 2(a); FIG. 2(f) is a front elevational view of the wireless transmitter unit of FIG. 2(a); and FIG. 2(g) is a rear elevational view of the wireless transmitter unit of FIG. 2(a).

FIG. 3(a) is a perspective view of an amplifier/receiver module constructed in accordance with one embodiment, with the outer casing shown in translucent form for viewing of the amplifier/receiver unit; and FIG. 3(b) is a front view of the amplifier/receiver module.

FIG. 4 is a front view of the front member and side attachment members of the amplifier/receiver module housing for encasing the amplifier/receiver module of FIG. 3(a) and FIG. 3(b).

FIG. 5(a) is a perspective view of an amplifier/receiver module housing for placement within a wall of a structure; FIG. 5(b) is a front elevational view of the amplifier/receiver module housing; FIG. 5(c) is a rear elevational view of the amplifier/receiver module housing; FIG. 5(d) is a top plan of the amplifier/receiver module housing; FIG. 5(e) is a bottom plan view of the amplifier/receiver module housing; FIG. 5(f) is a right side elevational view of the amplifier/receiver module housing; and FIG. 5(g) is a left side elevational view of the amplifier/receiver module housing.

FIG. 6 is a representation of an in-wall amplifier/receiver module cover constructed according to various embodiments.

FIG. 7 is a flow chart showing a process by which amplifier/receiver module is installed within a wall according to one particular embodiment.

FIG. 8 is a flow chart showing a process by which amplifier/receiver module is installed on a wall, as opposed to within the wall, according to one particular embodiment.

FIG. 9 is a representation showing the end result of an on-wall installation of the amplifier/receiver module.

FIG. 10 is a flow chart depicting a process by which the wireless audio distribution system may be arranged and set up according to one embodiment.

### DETAILED DESCRIPTION OF VARIOUS EMBODIMENTS

Various embodiments provide for a wireless audio distribution system that is used to wirelessly transmit audio from a wireless transmitter to one or more speakers located remote from the wireless transmitter. A plurality of channels of audio (up to eight channels in one implementation) are acoustically connected to the wireless transmitter unit. The wireless transmitter unit is configured for placement within a standard audio/video equipment rack. The wireless transmitter unit also has provisions for the remote mounting of the transmitting antenna (relative to the rest of the transmitter unit) using an extension cable. As a result, this arrangement operates without the wireless audio signals suffering from substantial degradation resulting from such placement. The channels of audio are at least selectively transmitted wirelessly to an amplifier/receiver module either located on a wall or contained within the wall or other structure such as a drop ceiling. In the situation where the amplifier/receiver module is recessed within the wall, a low profile cover is attached to the wall, concealing the amplifier/receiver module from view.

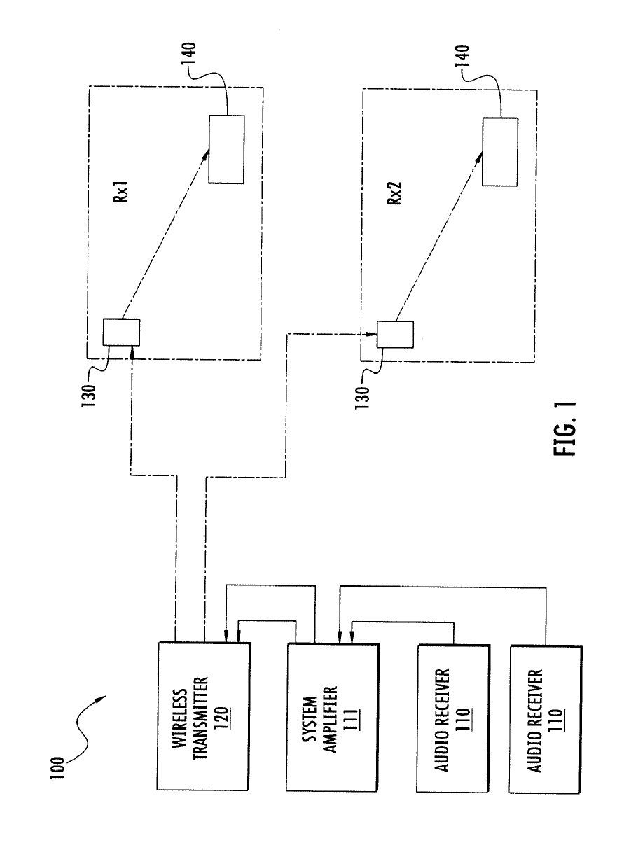

FIG. 1 is a schematic representation of a wireless audio distribution system 100 constructed in accordance with various embodiments. As shown in FIG. 1, a plurality of audio receivers 110 are included for receiving and processing audio signal. These signals are sent to a system amplifier 111 for distribution (wirelessly) to various remote speakers. This arrangement removes the need for speaker wires to run from the system amplifier 111 to each speaker throughout the home or building. Some or all of the audio outputs for the system amplifier 111 are communicatively coupled to a wireless transmitter 120, typically via a wired connection. The wireless transmitter 120 is configured to transmit audio received from the plurality of audio receivers 110 to various locations within the transmission area of the wireless transmitter 120. In particular embodiments, the transmission area will cover all or a significant portion of the space within a house, apartment, office, or the like. Individual receiver/amplifier modules 130 are positioned throughout the transmission area. Each receiver/amplifier module 130 is configured to receive audio signals transmitted by the wireless transmitter. Each amplifier/receiver module 130 is operatively connected to an individual speaker system 140 for the ultimate transmission and exhibition of the audio signals.

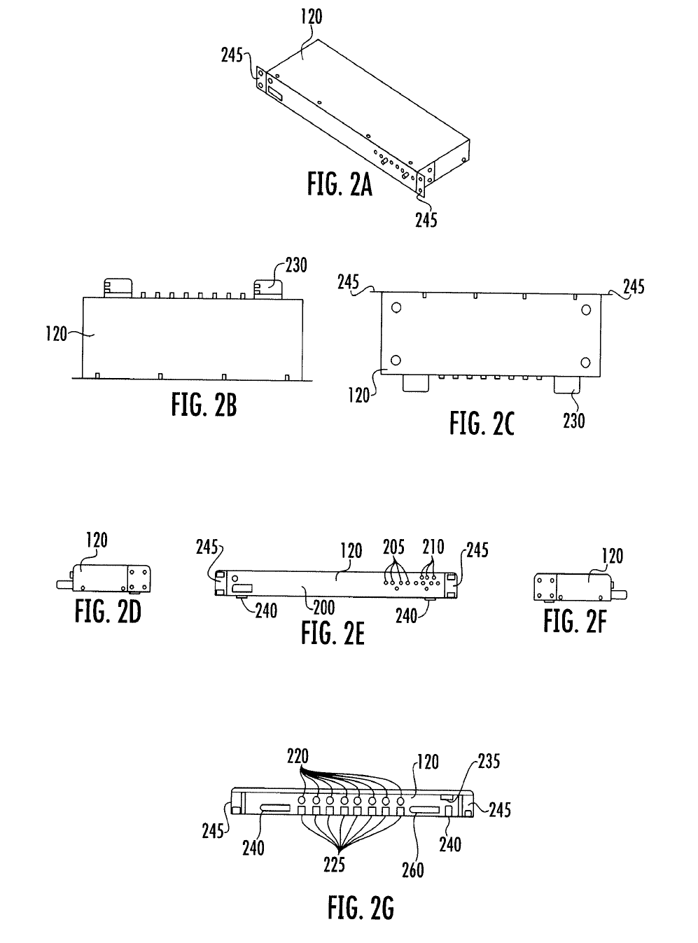

FIG. 2(a) is a front perspective view of a wireless transmitter 120 constructed in accordance with one embodiment, and FIG. 2(g) is a rear perspective view of the same wireless transmitter 120. A front surface 200 of the wireless transmitter 120 may include a plurality of buttons or similar channel actuators 205 that are used to properly synchronize the various audio channels with the speaker system(s) 140 to be associated therewith. Individual lights 210 above each actuator 205 are used to indicate the state of the individual channels. By way of example, a green light may indicate that a channel is on or “live,” and a blue light may indicate that the channel is properly synchronized with one or more speaker systems 140. The wireless transmitter 120 also includes a codec chip in a wireless transmitter module 230 (best shown in FIGS. 2(b) and 2(c)). The wireless transmitter module 230 permits the wireless transmitter 120 to interface with wirelessly associated amplifier/receiver modules 130.

As shown in FIG. 2(g), a rear surface 215 of the wireless transmitter 120 includes a line level inputs 220 and a plurality of speaker level inputs 225, with one line level input 220 and one speaker level input 225 for each transmission channel (with eight total channels in the embodiment depicted in FIGS. 2(a) and 2(b)). In one particular embodiment, each line level input 220 comprises an RCA line level input. The rear surface 215 shown in FIG. 2(b) also includes a pair of plugs 230 for the transmission modules, as well as a reservoir 235 for a power supply. In one embodiment, the wireless transmitter 120 uses a 120V to DC power supply, which is secured within the reservoir 235.

The wireless transmitter 120 also includes a plurality of feet 240. The feet 240 are used to support the wireless transmitter 120 when it is resting on a surface. Because the wireless transmitter module 230 is removable, an installer or user can move the wireless transmitter module 230 to a different location via a cable in a particular embodiment. This is beneficial because positioning the wireless transmitter antenna away from a rack may allow the wireless system to operate most effectively than when it is rack-mounted, as steel can block WiFi signals. Alternatively, instead of incorporating a cable between the wireless transmitter 120 and the wireless transmitter module 230, a cable may be coupled between the wireless transmitter module 230 and an associated antenna. This permits the position of the antenna to be moved away from the rack without adjusting the position of the wireless transmitter module (thereby reducing or eliminating potential transmission interference caused by the rack). It should also be noted that other components of the wireless transmitter module 230 may be removable or replaceable, and there may also be open ports or slots on the wireless transmitter module 230 to allow for future expansion of components and capabilities.

In one embodiment, the feet 240 are easily removable. For example, the feet 240 may be secured to the underside of the wireless transmitter 120 via a “stick on”/easily removable adhesive. As such, the feet 240 may be removed from the wireless transmitter 120 when the wireless transmitter is to be mounted in an audio/video equipment rack. In those situations where the wireless transmitter 120 is to be rack-mounted, a plurality of ears 245 may be attached to the sides or other surfaces of the wireless transmitter 120. The ears 245 may then be attached or slidably associated with the appropriate slot in the equipment rack.

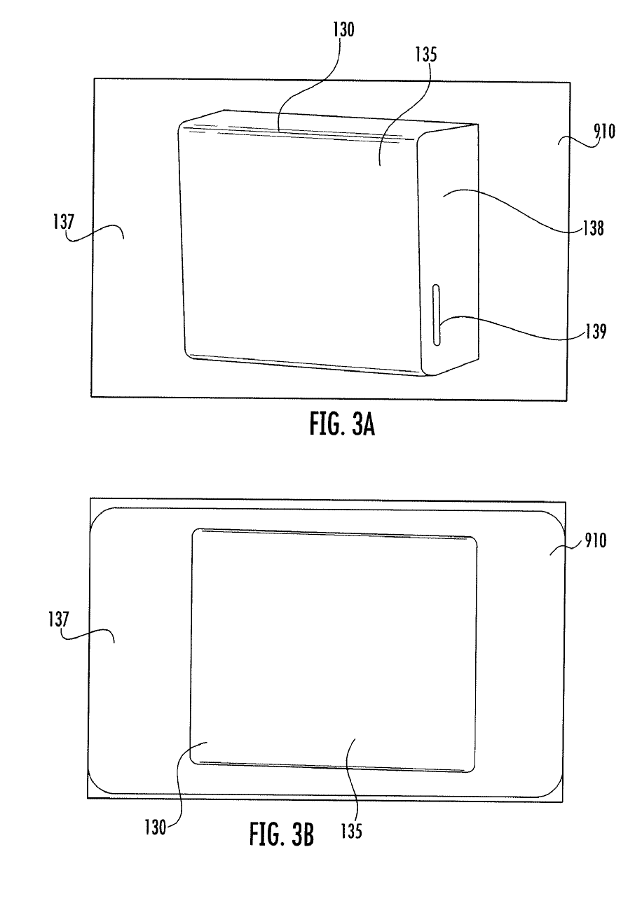

The amplifier/receiver module 130, as shown in FIGS. 3(a) and 3(b) contains a combination of an amplifier module 135 and a receiver module 137. In one implementation, the amplifier module 135 comprises a small amplifier/receiver module housing 500 (a steel box in one embodiment) containing a 120V AC to DC power converter and a 25 watt×2 amp amplifier. In the case of the power converter, this is required because most amplifiers in the audio distribution market operate on direct current, as opposed to alternating current. A power supply (e.g., the power source of the building) is connected to the amplifier via a wired connection. Additionally, speaker wires from an associated speaker system 140 are attached to a plug connector associated with the amplifier.

A receiver module 137 plugs into or is otherwise coupled to the amplifier module 135 via one or more speaker plug connections 139. In one implementation, the amplifier module 135 carries CE listings and also a UL2043 plenum rating, thereby permitting the amplifier to be placed in a wall, in a plenum, or on a wall with a power cord exposed and emanating therefrom to an outlet or other power source. The amplifier module 135 may also include a power LED or operation indication LED, as well as a user changeable power fuse.

Each receiver module 137 contains a radio chip configured to receive wireless signals transmitted by the wireless transmitter 120. Each receiver module 137 also includes an antenna, on/off button, and a link button. In one particular embodiment, the individual receiver modules 137 may be configured for both stereo (2 channel) and mono (1 channel) model reception.

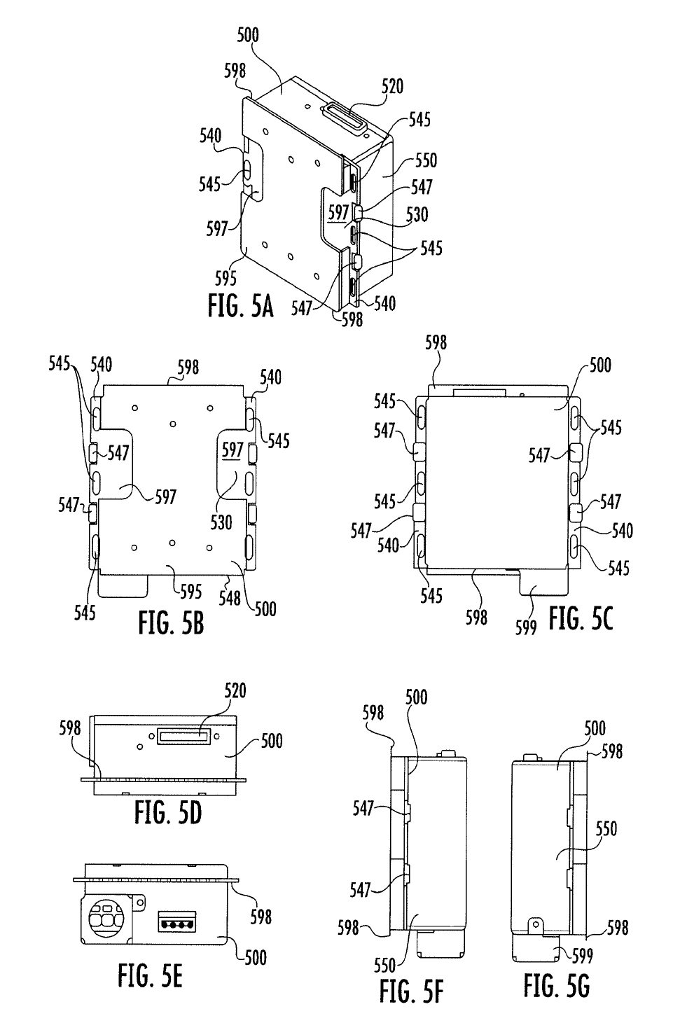

FIG. 5 is a perspective view of an amplifier/receiver module housing 500 for placement within a wall of a structure. The amplifier/receiver module housing 500 includes a housing opening 520 sized and configured such that the receiver codec chip may protrude therethrough. A front surface 530 of the amplifier/receiver module housing 500 includes flanges 540 that extend slightly beyond the side walls 550 of the amplifier/receiver module housing 500. The flanges 540 include one or more housing flange openings 545 through which a screw or other fastener may pass, as is discussed in greater detail below. The flanges 540 may also include a plurality of offset tabs 547 that may be used to attach a plastic cover to the amplifier/receiver module housing 500, such that the entire amplifier/receiver module housing 500 is concealed, when the amplifier/receiver module 130 is being positioned on (as opposed to within) a wall or is otherwise being positioned in a more exposed area. It should be noted that, in addition to on-wall and in-wall installations, the amplifier/receiver modules 137 may also be mounted within a ceiling, for example to more easily enable the use of ceiling mounted speakers.

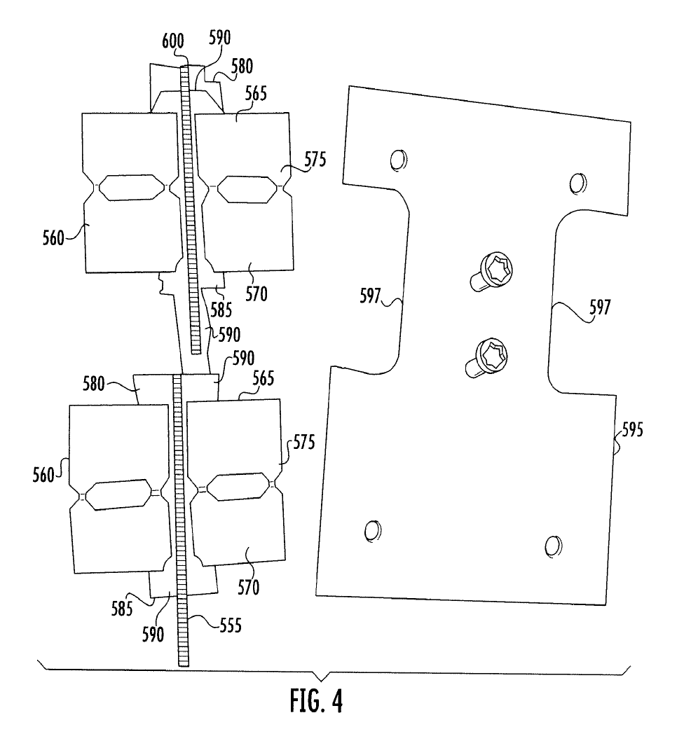

As shown in FIG. 4, the amplifier/receiver module housing 500 also includes a pair of clamps 560 which, when the amplifier/receiver module housing 500 is to be recessed within a wall, are coupled to the amplifier/receiver module housing 500 along the side walls 550. As shown in FIG. 4, each clamp 560 comprises a clamp upper portion 565, a clamp lower portion 570, a clamp hinge 575 positioned between the clamp upper portion 565 and the clamp lower portion 570, an upper clamp flange 580 extending away from the clamp upper portion 565, and a lower clamp flange 585 extending away from the clamp lower portion 570. Both the upper clamp flange 580 and the lower clamp flange 585 include a clamp flange opening 590 sized and configured to accept a fastener 555 that passes through the housing flange openings 545. As discussed in greater detail below, the clamps 560 are used to secure the amplifier/receiver module housing 500 within a wall such that the amplifier/receiver module housing 500 is recessed and concealed from view. In one particular embodiment, the clamps 560 comprise Raco model 966 drywall clamps, although the precise type and model of clamp 560 can vary.

In a particular embodiment, the amplifier/receiver module housing 500 includes a holding bracket 595 that is operatively connected to the front surface 530 of the amplifier/receiver module housing 500. The holding bracket 595 includes a plurality of finger holds 597 that are strategically positioned such that the user can easily hold the amplifier/receiver module housing 500 while positioning it within a recess of a wall. In the use situation where the amplifier/receiver module housing 500 is not to be recessed within a wall, then the holding bracket 595 is not necessary. In a particular embodiment, the holding bracket 595 and the front surface 530 (and by extension the flanges 540) are combined as a single component. The finger holds 597 allow the user/installer to grasp the amplifier/receiver module housing 500 easily and position the amplifier/receiver module housing 500 into the wall.

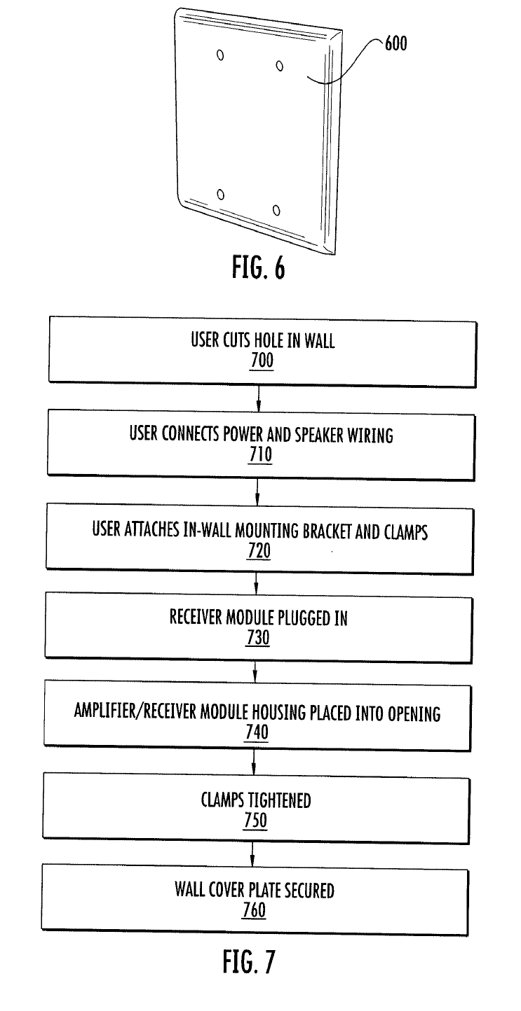

In the use situation where the amplifier/receiver module 130 is to be positioned within a wall, the fasteners 555 are used to secure one clamp 560 to respective side walls 550 of the amplifier/receiver module housing 500 (with the amplifier/receiver module 130 contained therein). Once the amplifier/receiver module housing 500 has been positioned within the wall, the user tightens the fasteners 555 (for example, when screws are used, by turning screws in a clockwise direction in one embodiment). This causes each clamp 560 to compress along the axis of the respective fasteners 555, meaning that each clamp upper portion 565 and clamp lower portion 570 move towards each other, resulting in both portions pivoting outwardly and away from the side walls 550 along the clamp hinge 575. This also results in an amount of forward movement of the upper clamp portion 565 and the lower clamp portion 570 along the clamp hinge 575. As a result of these movements, the clamps 560 press against the inside surface of the wall, thereby clamping the amplifier/receiver module housing 500, with upper and lower flanges 598 of the holding bracket 595 being located on the outside of the wall and the clamps 560 on and against the inside of the wall. An in-wall amplifier/receiver module cover 600 (shown in FIG. 6) may then be used to conceal the amplifier/receiver module housing 500, and the opening in the wall, from view. The amplifier/receiver module cover 600 attaches to the holding bracket 595 via a plurality of screws or other fasteners.

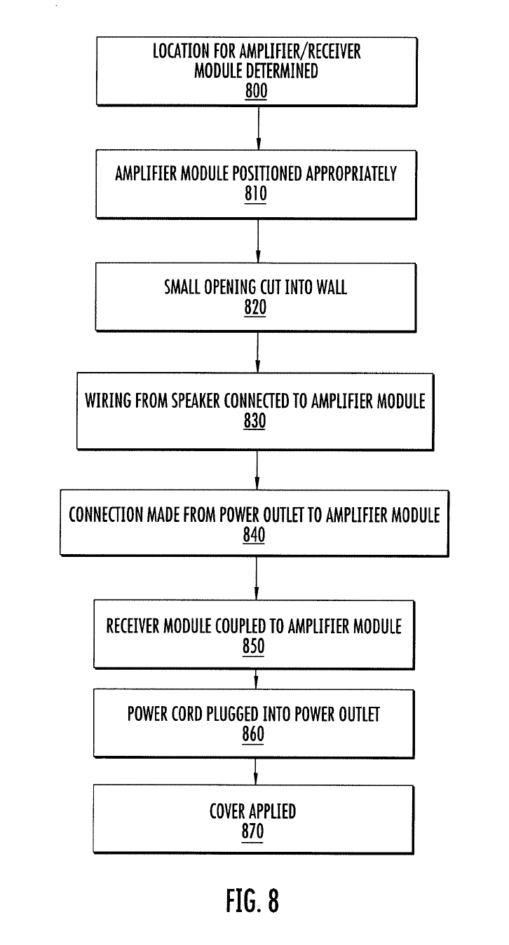

FIG. 7 is a flow chart showing a process by which amplifier/receiver module 130 is installed within a wall according to one particular embodiment. At 700 in FIG. 7, a user cuts a hole in a wall of a size that is sufficient to securely accept the amplifier/receiver module housing 500. In this implementation, it is important that the opening not be made in front of a wall stud, so that there is sufficient room for the amplifier/receiver module housing 500 therein. At 710, the user properly connects the requisite power and speaker wire routing and connections to the amplifier module 135. At 720, the user attaches the proper in-wall mounting accessories to the amplifier/receiver module housing 500. In particular, the holding bracket 595 is attached to the front surface 530 of the amplifier/receiver module housing 500, and clamps 560 are attached on each side of the amplifier/receiver module housing 500. At 730, the receiver module 137 is plugged into the amplifier module 135. At this point or later (not shown), the wireless link is established between the receiver module 137 and the wireless transmitter 120. At 740, the amplifier/receiver module housing 500 (with the amplifier/receiver module 130 therein) is placed into the opening. In one implementation, this is accomplished by moving the amplifier/receiver module housing 500 downward as it moves into the opening. Once the amplifier/receiver module housing 500 is inside the opening, it is moved upwards and outwards so that it can rest on lower exposed surface of the opening in the wall. At 750, the clamps 560 are tightened in the manner described previously, causing the amplifier/receiver module housing 500 to be secured inside the opening against the inside surface of the wall. At 760, a wall cover plate is secured to the front surface of the holding bracket 595 (via cover plate openings 597 formed in the holding bracket), thereby concealing the amplifier/receiver module housing 500 from view. In one embodiment, the wall cover plate may comprise a standard 2 gang oversize flat cover plate. Additionally, a conduit adapter 599 may be provided as an accessory in order to allow the connection of flexible conduit, as required to meet electrical codes in specific geographical areas.

FIG. 8 is a flow chart showing a process by which amplifier/receiver module 130 is installed on a wall, as opposed to within the wall, according to one particular embodiment. At 800 in FIG. 8, a desired location on the wall for the amplifier/receiver module 130 is determined. In a particular embodiment, it is helpful for the amplifier/receiver module 130 to be located within about a foot of a power outlet so that power can be properly and easily supplied to the amplifier module 135. At 810, the amplifier module 135 is located on the wall and oriented substantially horizontally such that the power connection 138 is facing the power outlet which will be the source of power for the amplifier/receiver module 130. In an alternative implementation, there may be a situation where the amplifier module 135 is oriented substantially vertically, so long as the stud to which the power outlet is secured is not under a desired wiring penetration.

At 820 in FIG. 8, the user cuts a small opening of a defined sized into the wall, next to the speaker wiring connector of the amplifier/receiver module 130. In alternative implementations, particularly where the amplifier/receiver module 130 is to be positioned “on” the wall rather than within it (for example, where the wall is made of cinder block and/or cement), process 820 may not have to be performed. At 830, the wiring from the to-be-associated speaker is connected to the receiver module 137. At 840, a proper power connection is made between the power outlet and the amplifier module 135. In one embodiment, this is accomplished by taking a power plug cable, cutting it to a desired length, stripping three leads at the end which is to be connected to the amplifier module 135, and pushing each of the leads into the proper location on the amplifier module 135. At 850, the receiver module 137 is coupled to the amplifier module 135. At 860, the power cord is plugged into the power outlet, and a communication link between the receiver module 137 and the wireless transmitter 120 is established. At 870, the amplifier/receiver module 130 and the associated wiring is covered with an appropriate cover.

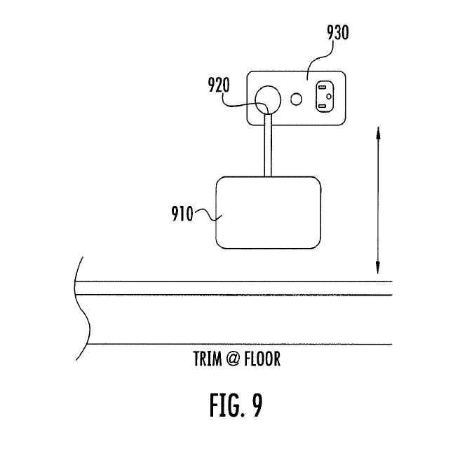

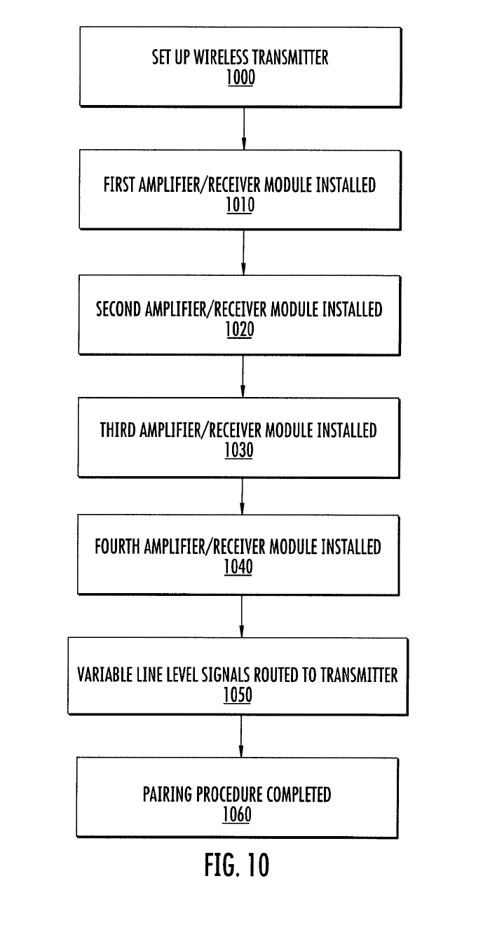

FIG. 9 is a representation showing the end result of an on-wall installation of the amplifier/receiver module 130. As shown in FIG. 9, an on-wall cover 910 covers the amplifier/receiver module 130 (represented in phantom). A power cord runs from the amplifier/receiver module 130 to an associated power outlet 930. In one embodiment, the power cord 920 comprises a right angle power plug cable, although other power cord types are also possible. The on-wall cover 910 may be part of a “kit” along with the amplifier/receiver module 130 (along with an in-wall kit and one or more cable whips of various lengths), or it may be supplied and/or sold as an entirely separate component.

FIG. 10 is a flow chart depicting a process by which the wireless audio distribution system may be arranged and set up according to one embodiment. At 1000 in FIG. 10, the wireless transmitter unit 120 is set up. This may comprise, for example, either mounting the wireless transmitter 120 within a rack, or placing the wireless transmitter (with feet attached) on an appropriate surface. At 1010, an amplifier/receiver module 130 is installed inside a bathroom wall (with a single power connection and a pair of speaker connections for stereo sound). At 1020, another amplifier/receiver module 130 is installed within a bedroom ceiling. Again, a single power connection and a pair of speaker connections are utilized for stereo sound. At 1030, yet another amplifier/receiver module 130 is installed inside a kitchen wall, with a single power connection and a pair of speaker connections for stereo sound. At 1040, still another amplifier/receiver module 130 is installed inside a bedroom ceiling, with a single power connection and a pair of speaker connections for stereo sound. At 1050, variable line level signals and/or speaker level inputs are routed to the wireless transmitter 120. In this particular implementation, the inputs are paired 1-2, 3-4, 5-6 and 7-8. At 1060, the pairing procedure is completed between transmitter channels 1-8 and the four separate amplifier/receiver modules 130, with two channels being dedicated for each amplifier/receiver module 130 (thereby enabling stereo sound at each speaker system 140).

As discussed above with regard to FIG. 10, stereo connections may be accomplished in various embodiments by having two channels routed both into the wireless transmitter 120 from a source and out of the wireless transmitter 120 to an individual amplifier/receiver module 130. Alternatively, individual speaker systems 140 can be set up for mono mode by having one channel routed into the wireless transmitter 120 from a source and a corresponding single channel to the respective amplifier/receiver module 137 configured for mono operation.

The wireless audio distribution system 100 described herein is modular in nature. This modular design allows for the altering of pre-installed products at a later date, and components may be selected across multiple product lines. The modular design, according to various embodiments, results in a simpler method of replacing individual components. Should a problem arise with the wireless portion of the system, that individual part, whether it is the wireless transmitter, the receiver module 137, or the amplifier, can be troubleshot and replaced individually. Additionally, this arrangement provides for increased overall flexibility in the system, as the individual component items can be mixed and matched, thereby enabling multiple modes of operation. By way of example, an installer can utilize an amplifier in either a stereo 2 channel mode with a stereo receiver module 137, or a high power mono 1 channel mode with a mono receiver module 137. The installer could also change the mode from mono to stereo at a later date if the connected speaker changes to a upgraded bi-amped model or version. Along these lines, the system enables a simpler method of upgradeability, as the various receivers and transmitters can be easily updated after the initial installation in order to provide upgraded performance and operations.

Although various embodiments have been described in detail in this disclosure, those skilled in the art who review this disclosure will readily appreciate that many modifications are possible without materially departing from the novel teachings and advantages of the subject matter described herein. By way of example, the various components of the wireless audio distribution system 100 can possesses a variety of ratings, power and energy capacities, etc. in order to meet current or future system and environmental requirements. The order or sequence of any method processes may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A wireless audio distribution system, comprising:
a transmitter unit, the transmitter unit configured to wirelessly transmit a plurality of channels of audio; and
an amplifier/receiver module wirelessly connected to the transmitter unit, the amplifier/receiver module including an amplifier module coupled to a receiver module, the amplifier/receiver module configured to at least selectively receive at least one of the plurality of channels of audio from the transmitter unit.

2. The wireless audio distribution system of claim 1, further comprising an amplifier/receiver module housing, the amplifier/receiver module housing including a region for receiving the amplifier/receiver module and further configured to be secured within a mounting surface.

3. The wireless audio distribution system of claim 2, wherein the amplifier/receiver module housing includes a plurality of clamps configured to selectively brace the amplifier/receiver module housing to a rear surface of the mounting surface, thereby securing the amplifier/receiver module housing within the mounting surface.

4. The wireless audio distribution system of claim 1, wherein the transmitter unit is mountable within an equipment rack.

5. The wireless audio distribution system of claim 2, wherein the amplifier/receiver module housing includes a receiver opening positioned such that at least a portion of the receiver module may pass therethrough.

6. The wireless audio distribution system of claim 1, wherein the transmitter unit and the receiver module each include a communicatively aligned codec chip, thereby enabling wireless transmissions transmitted by the wireless transmitter to be received and processed by the receiver module.

7. The wireless audio distribution system of claim 1, wherein the transmitter unit includes:
a transmitting antenna, and an extension cable coupled between the transmitting antenna and the remainder of the transmitter unit, thereby permitting positioning of the transmitting antenna remote from the remainder of the transmitter unit.

8. The wireless audio distribution system of claim 2, wherein the amplifier/receiver module housing includes a front surface and a plurality of side walls each positioned substantially perpendicular to the front surface, and wherein the front surface includes a plurality of flanges that extend beyond the plurality of side walls, the plurality of flanges configured to be positioned on an outside of the mounting surface.

9. The wireless audio distribution system of claim 8, wherein the amplifier/receiver module housing further includes a holding bracket operatively connected to the front surface, the holding bracket including a plurality of finger holds positioned for use by user when positioning the amplifier/receiver module housing within a wall.

10. The wireless audio distribution system of claim 1, wherein the receiver module of the amplifier/receiver module is configured to at least selectively receive at least one of the plurality of channels of audio from the transmitter unit, and wherein the amplifier module of the amplifier/receiver module is configured to amplify the received at least one channel of audio for distribution to a communicatively associated speaker.

11. A combination amplifier/receiver module assembly for use in a wireless audio distribution system, comprising:
an amplifier/receiver module configured for wireless communication with a remote audio transmitter unit, the amplifier/receiver module including an amplifier module coupled to a receiver module, the receiver module configured to at least selectively receive at least one of a plurality of channels of audio from the remote audio transmitter unit, the amplifier module configured to amplify the received at least one of a plurality of channels of audio for distribution to an associated speaker; and
an amplifier/receiver module housing, the amplifier/receiver module housing including a region for receiving the amplifier/receiver module and further configured to be secured within a mounting surface.

12. The combination amplifier/receiver module assembly of claim 11, wherein the amplifier/receiver module housing includes a housing opening formed therein, the housing opening sized and configured to permit a receiver codec chip to protrude therethrough when the amplifier/receiver module is positioned within the amplifier/receiver module housing.

13. The combination amplifier/receiver module assembly of claim 11, wherein the amplifier/receiver module housing includes a front surface and a plurality of side walls each positioned substantially perpendicular to the front surface, and wherein the front surface includes a plurality of flanges that extend beyond the plurality of side walls, and wherein the plurality of flanges are configured to be positioned on an outside of the mounting surface.

14. The combination amplifier/receiver module assembly of claim 13, wherein the amplifier/receiver module housing further includes a holding bracket operatively connected to the front surface, the holding bracket including a plurality of finger holds positioned for use by user when positioning the amplifier/receiver module housing within the mounting surface.

15. The combination amplifier/receiver module assembly of claim 11, further comprising a plurality of clamps at least selectively coupled to the amplifier/receiver module housing and configured to selectively brace the amplifier/receiver module housing to a rear surface of a mounting surface, thereby securing the amplifier/receiver module housing within the mounting surface.

16. A wireless audio distribution system, comprising:
an audio transmitter unit, the audio transmitter unit configured to wirelessly transmit a plurality of channels of audio; and
a plurality of amplifier/receiver module assemblies wirelessly connected to the audio transmitter unit, each of the plurality of amplifier/receiver module assemblies including an amplifier/receiver module comprising an amplifier module coupled to a receiver module, the receiver module configured to at least selectively receive at least one channel of audio from the audio transmitter unit, the amplifier module configured to amplify the received at least one channel of audio for distribution to a communicatively associated speaker.

17. The wireless audio distribution system of claim 16, each of the plurality of amplifier/receiver module assemblies further include an amplifier/receiver module housing comprising a region for receiving the amplifier/receiver module, the amplifier/receiver module housing configured to be secured within a mounting surface.

18. The wireless audio distribution system of claim 17, wherein each amplifier/receiver module housing includes a plurality of clamps configured to selectively brace the amplifier/receiver module housing to a rear surface of the mounting surface, thereby securing the amplifier/receiver module housing within the mounting surface.

19. The wireless audio distribution system of claim 18, wherein each amplifier/receiver module housing includes a front surface and a plurality of side walls each positioned substantially perpendicular to the front surface, and wherein the front surface includes a plurality of flanges that extend beyond the plurality of side walls.

20. The wireless audio distribution system of claim 16, wherein the audio transmitter unit and the receiver module of each amplifier/receiver module include a communicatively aligned codec chip, thereby enabling wireless transmissions transmitted by the wireless audio transmitter to be received and processed by the receiver module.
